(19) United States
(12) Patent Application Publication
(10) Pub. No.: US 2005/0050314 A1
(43) Pub. Date: Mar. 3, 2005

(54) Electronic apparatus and method for starting up system of such apparatus

(76) Inventors: Fumio Ohkita, Yokohama (JP); Yasushi Naito, Yokohama (JP); Shigeru Hirahata, Oiso (JP); Satoshi Takahashi, Chigasaki (JP); Tomohiko Mizuguchi, Mishima (JP); Satoshi Iimuro, Yokohama (JP)

Correspondence Address: MCDERMOTT WILL & EMERY LLP, 600 13th Street, N.W., Washington, DC, 20005-3096, US

(21) Appl. No.: 10/892,487

(22) Filed: Jul. 16, 2004

(30) Foreign Application Priority Data
Aug. 27, 2003 (JP) 2003-302799

(51) Int. Cl. G06F 9/00

(52) U.S. Cl. 713/2; 711/165

(57) ABSTRACT

For providing an electronic apparatus, into which a semiconductor memory, being unavailable random accessing thereon, is installed as a memory for storing control programs therein, as well as, a start-up method for a system thereof, an electronic apparatus has a controller for executing control on each portion of the apparatus. The controller comprises a CPU 201 and a non-volatile memory 203, being electrically erasable and writable data thereof and having a function of reading out data locating at specific addresses, continuously, such as, a flash memory of “NAND” type, representatively, wherein continuous addresses are generated responding to a reset signal, so as to read out a boot program stored in a portion of the non-volatile memory, continuously, when executing the start-up of the system, and also the boot program is extended on a volatile memory 202, being accessible at random to data thereof.

### BACKGROUND OF THE INVENTION

The present invention relates to an electronic apparatus having a semiconductor memory within an inside thereof, and in particular, it relates to a structure and a start-up method thereof, for starting up a system in the apparatus, having a built-in semiconductor memory, which is called by “AND” type or “NAND” type.

Accompanying a current in recent years, in particular, of large-sizing of the memory capacity of the semiconductor memory, as well as, small-sizing of a microcomputer, a microcomputer or an electronic apparatus, each having the built-in semiconductor memory device therein (hereinafter, being called by only the name of “electronic apparatus”, collectively), comes to be spread or popularized, and it is also applied into, widely, such as, a portable telephone apparatus, or a digital broadcast receiving system of being called by, such as, “Set Top Box (STB)”, for example, to be a controller thereof. The following conventional arts are already known, relating to such the apparatus; i.e., Japanese Patent Laying-Open No. 2003-134492 (2003), Japanese Patent Laying-Open No. 2003-122578 (2003), Japanese Patent Laying-Open No. 2003-124899 (2003), and Japanese Patent Laying-Open No. 2003-125304 (2003), for example.

On the other hand, relating to the semiconductor memory devices, in particular, a DRAM (Dynamic Random Access Memory) is spread or applied into, widely, because of cheapness in the bit cost (i.e., the price per one (1) bit) thereof, comparing to those of other memories, however it has a limit in the variety of use thereof since it cannot hold data recorded therein if it is tuned off the electric power source therefrom (i.e., the volatile characteristic thereof).

However, in recent years, widely used is a semiconductor memory, which is called by a “flash memory”, as well as, the conventional types of memories, such as, MROM, PROM, UV-EPROM, EEPROM, for example, as such a non-volatile memory of being electrically erasable and writable data therein. Roughly, this flash memory can be classified into (1) a “NOR” type and (2) a “NAND” type, and each of them has the following characteristics, respectively.

Namely, (1) the “NOR” type flash memory is a memory, onto which random access can be made, and it is also higher in the read-out speed comparing to that of (2) the “NAND” type; therefore, it is widely used, as the memory for storing the control program therein, in particular, in relatively small-sized electronic apparatuses, such as, the portable telephone apparatus, or the like, for example. However, on the contrary thereof, the “NOR” type flash memory is difficult to be made large in the memory capacity thereof, and being expensive, as well, and further it has a drawback that it takes along time for executing write-in and erasing of data therein.

On the contrary to this, (2) the “NAND” type flash memory can be reduce sharply, in the memory sizes thereof, due to the structure thereof; therefore, it has the most remarkable feature as a large-sized capacity memory, being cheap in the bit cost thereof. However, since it reads out data locating within specific addresses, continuously, because the “NAND” type flash memory is of, so-called, a synchronous read-out type; therefore, it is mainly used in a field of, such as, re-wiring or reading-out by a specific unit of block data, in particular, in relation to the use thereof. For example, it is possible for a digital camera having 3,000,000 pixels, to take pictures of 64 pieces or more with using a flash memory card of 64 Mbites (512 Mbits), for this reason, the “NAND” type flash memory is widely used in this field.

Also, in Japanese Patent Laying-Open No. 2002-366429(2002), for example, there is already known a semiconductor memory device, in which a chip of the flash memory and a chip of DRAM are provided through a controller circuit (i.e., CTR_LOGOC), within a module mounted into one (1) package, so as to transmit the data of the flash memory to the DRAM, while access is made to the DRAM, thereby obtaining an adjustment or coordination in the access time, for achieving the coordination between the access time of a non-volatile memory of large memory capacity, such as, the “NAND” type flash memory, representatively, and that of the so-called random access memory, being such as, the DRAM, representatively, or in other words, for bringing the read-out and write-in speed of data from/into the flash memory to be equal to that of the SDRAM and/or SRAM.

### SUMMARY OF THE INVENTION

However, with such the conventional arts mentioned above, there are still such the problems, as follows. Thus, with the broadcast receiving apparatus and/or a system thereof, which are known in the published documents mentioned above, they have a problem that, it is impossible to use such the non-volatile memory therein, though being cheap in the price and large in the memory capacity thereof, such as, the (2) “NAND” type flash memory, for example, as being the memory for memorizing the control programs therein. Further, for such the electronic apparatuses of being relatively small in the sizes, such as, the broadcast receiving apparatus and/or the potable telephone apparatus mentioned above, in particular, in recent years, the tendency of multifunction and/or high performances are remarkable, and therefore it is strongly demanded to adopt the non-volatile memory of large memory capacity to be the memory for memorizing the control programs therein.

Also, in particular, with the semiconductor memory device that is already known in the Japanese Patent Laying-Open No. 2002-366429 (2002) mentioned above, it is necessary to provide a chip of the controller circuit (i.e., CTR_LOGIC) and also a chip of the DRAM, further, together with a chip of the flash memory, within that memory device; therefore, it is difficult to apply that to be the memory for memorizing the control programs therein, in particular, in such the electronic apparatuses of being relatively small in the sizes thereof, such as, the portable telephone apparatus, or the like.

Then, according to the present invention, by taking the problems relating to the above-mentioned conventional arts into the consideration thereof, an object thereof is to provide a novel structure within an electronic apparatus, into which a flash memory can be installed or applied, though it is erasable and writable data therein, electrically, but being unable to obtain the random accessing thereto, therefore, having the synchronous read-out function; such as, the flash memory of the (2) “NAND” type mentioned above, for example, representatively, and also to provide a start-up method for starting up the system thereof, upon the structure of such the apparatus.

For achieving the objection mentioned above, according to the present invention, first, there is provided an electronic apparatus, having a controller portion for executing control on each part of said apparatus, wherein said controller portion comprises: a central processing unit; a volatile memory portion, being connected with said central processing unit and accessible at random thereto; a non-volatile memory portion, being connected with said central processing unit and electrically erasable and writable data thereof; and a reset signal generator portion for generating a reset signal for executing start-up of a system, wherein said non-volatile memory portion is made up with a flash memory, having a function of reading out data locating at specific addresses, continuously, and also storing a boot program for executing start-up of the system in a part thereof, and further, said controller portion comprises means for generating said specific addresses responding to the reset signal from said reset signal generator portion, whereby said central processing unit starts up upon basis of the boot program, which is read out from said non-volatile memory portion continuously.

Also, according to the present invention, the electronic apparatus as described in the above, wherein said central processing unit extends the data, which are read out continuously from said non-volatile memory, on the volatile memory portion, being connected with said central processing unit and accessible at random thereto, as well as, starting up upon basis of the boot program, which is read out from said non-volatile memory portion continuously; or alternatively, said controller portion further comprises a means, for producing a signal so as to read out the data locating at the specific addresses continuously, responding to the reset signal from said reset signal generator portion, thereby outputting them to said non-volatile memory portion; or in said non-volatile memory portion is stored said boot program, sequentially, at the specific continuous addresses thereof; or in said controller portion further comprises an address change detector circuit for inputting addresses from said central processing unit, so as to detect change thereof.

In addition thereto, according to the present invention, the electronic apparatus as described in the above, wherein said apparatus is applied into a receiving system for digital broadcasting, or a portable telephone apparatus.

And, according to the present invention, also for accomplishing the object mentioned above, there is provided a method for starting up a system within an electronic apparatus having a controller portion for executing control on each of portions of the apparatus, wherein said controller portion comprises: a central processing unit and a non-volatile flash memory, being electrically erasable and writable data thereof and having a function of reading out data locating at specific addresses thereof, continuously, comprising the following steps of: storing a boot program for starting up a system into a portion of said non-volatile flash memory portion; and reading out said boot program, continuously, from said non-volatile flash memory portion, when a reset signal for starting up said system is generated, whereby executing the start-up.

Further, according to the present invention, the method for starting up a system as described in the above, preferably, said boot program is stored, sequentially, at specific continuous addresses within said non-volatile flash memory portion; or preferably, said controller portion further comprises a volatile memory portion being connected with said central processing unit and accessible at random to data thereof, and further said central processing unit starts up upon basis of the boot program, which is read out from said non-volatile memory portion, continuously, and also extends the data continuously read out from said non-volatile memory portion onto the volatile memory portion, being connected with said central processing unit and accessible at random to data thereof.

### BRIEF DESCRIPTION OF THE DRAWING

Those and other objects, features and advantages of the present invention will become more readily apparent from the following detailed description when taken in conjunction with the accompanying drawings wherein:

FIG. 1 is a block diagram for showing the internal construction of a controller, within a receiving system for use in digital broadcasting, according to one embodiment of the present invention;

FIG. 2 is a view for explaining the start-up operation of a program within the controller shown in FIG. 1 mentioned above;

FIG. 3 is a flowchart for explaining the operation of a CPU, in particular, when starting up the program within the controller shown in FIG. 1 mentioned above;

FIG. 4 is a view for explaining read-out of data from a flash memory of “AND” type or “NAND” type, in particular, when starting up the program mentioned above;

FIG. 5 is a block diagram for explaining an example of the entire structure of the receiving system for use in digital broadcasting, into which the controller (i.e., an electronic apparatus) mentioned above is applied, according to the present invention;

FIG. 6 is a block diagram for showing the internal construction of the controller, in particular, in a case where applying a CPU, which generates no read-out pulse output when changing the read-out addresses, according to a variation of the present invention;

FIG. 7 is a view for showing output waveforms, for explaining the operation of the CPU, which generates no read-out pulse output when changing the read-out addresses, for the purpose of explaining the background of the variation of the present invention;

FIG. 8 is a view for showing an example of the detailed circuit structure of an address change detector circuit of the controller, according to the variation of the present invention;

FIG. 9 is a view for showing output waveforms, for explaining the operation of the CPU, within the controller mentioned above according to the variation of the present invention, in which the address change detector circuit is provided; and

FIG. 10 is a block diagram of the controller (i.e., the electronic apparatus) mentioned above, according to the present invention, in particular, in the case when it is applied into a portable telephone apparatus of high performance type.

### DETAILED DESCRIPTION OF PREFERRED EMBODIMENTS

Hereinafter, embodiments according to the present invention will be fully explained, by referring to the attached drawings.

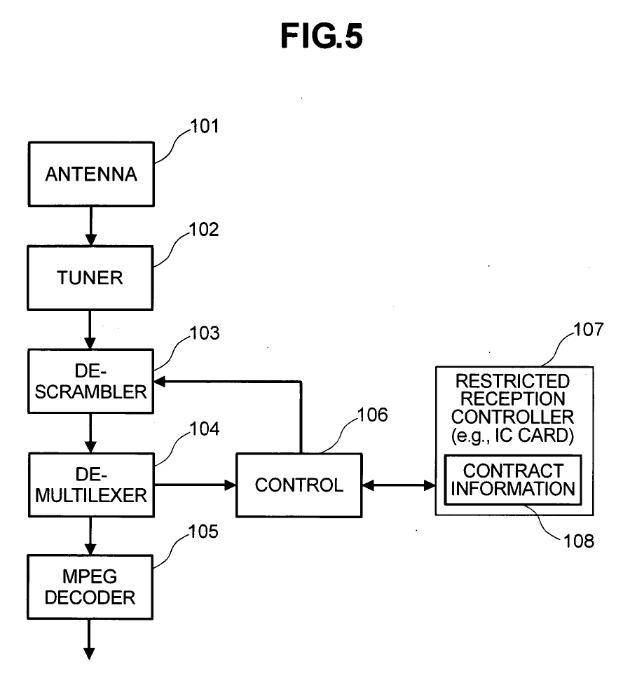

First, FIG. 5 shows an electronic apparatus according to one embodiment of the present invention, as being an example thereof, a receiving system for use in digital broadcasting (so-called, a Set Top Box; STB), enabling restrictive reception of the broadcasting, such as, the CATV (Cable Television), the CS (Communication Satellite) digital broadcast, the BS digital broadcast, or the ground digital broadcast, etc., for example, in which while scramble is made upon the broadcasting, only a contractor can dissolve the scramble, so as to view/listen the programs thereof. Thus, this receiving system for the digital broadcasting has a device for the restrictive reception, so that only the contractor can view/listen the programs, which are broadcasted.

In this FIG. 5, a reference numeral 101 depicts an antenna, 102 a tuner portion, 103 a de-scrambler for dissolving or de-scrambling the scramble, 104 a de-multiplexer for separating or dividing a desired signal from signals being multiplexed, 105 is an MPEG decoder, 106 a controller for conducting a reception control, 107 a restrictive reception control portion, for conducting management and/or control upon contract information and keys for use of the restrictive reception, and 108 a contract information portion for holding therein the contract information and keys, which are used within the restrictive receipt controller portion 107, respectively.

And, with such the structure of the receiving system for receiving the digital broadcast mentioned above, a signal transmitted by an undertaking company of communication (such as, a broadcasting company) is received by means of the antenna 101, and after being converted into an intermediate frequency (IF), it is transferred to the tuner portion 102. The tuner portion 102 demodulates it into a base-band signal, as well as, treating error correction, etc., thereupon, so as to provide an output to the de-scrambler 103. The de-scrambler 103 dissolves the scramble (de-scrambles) with an aid of a scramble dissolve or de-scramble key, which can be obtained from the restrictive receipt controller portion 107.

On the other hand, in an example of the BC digital broadcasting, the scramble is treated upon contents of video/audio/data, but not upon additional program information thereof, such as, the name of programs, for example, and an encryption is treated upon the restrictive reception control signals for achieving the restrictive reception of broadcasting; therefore, the dissolving of scramble, i.e., the de-scramble is made aiming at the contents, which are scrambled in the above. The signal de-scrambled is separated, within the de-multiplexer 104, into the signal desired, and the video/audio signals are guided into the MPEG decoder 105 while the additional program information and/or the restrictive reception control signal are/is guided through the controller 106 into the restrictive reception control portion 107. The video/audio signals are decoded within the MPEG decoder 105, thereby to be displayed on a television screen or the like. The controller 106 conducts such the reception control as was mentioned above, and in particular, it delivers the restrictive reception control signal to the restrictive reception control portion 107, while obtaining the de-scramble key mentioned above from the restrictive reception control portion 107, so as to set it into the de-scrambler 103; thereby de-scrambling the broadcasting scrambled, so as to be viewed/listened. Namely, the controller 106 executes the control on each portion of the receiving system for the digital broadcasting, in accordance with programs stored therein.

Further, in the case of this BS digital broadcasting, the restrictive reception control portion 107 is built up with an IC card, and the restrictive reception control signal is made up with the EMM (Entitlement Management Messager) and the ECM (Entitlement Control Message). Thus, when obtaining the EMM, which is the information in relation to the contract, to be delivered to the IC card 107, it is decrypted with an aid of a master key “Km” owned by the IC card 107, thereby setting up a work key “Kw” therefrom. Obtaining the ECM, i.e., the information for de-scrambling, which is broadcasted together with the programs scrambled, when it is delivered to the IC card 107, it is decrypted with an aid of the work key “Kw” set up therein, thereby obtaining a scramble key “Ks”. The controller 106 obtains the scramble key “Ks” mentioned above from the IC card 107, and set it into the de-scrambler 103.

As was mentioned above, the contract information is located within the IC card 107, and the key can be obtained therefrom, for de-scrambling the broadcast, on which the contract is made by means of that contract information therein. Also, though the IC card 107 is detachable, in the case of the BC broadcasting, however, this may be installed into the receiver apparatus in a form of an IC chip, for example, or in the place thereof, for a user to view/listen such the restrictive reception broadcasting as was mentioned above on a plural number of receiver apparatuses, there may be adopted a method, in which the de-scramble signals ECMs are delivered from the plural number of apparatuses to the restrictive reception control portion 107, with using a network, such as, the IEEE 1394, for example, to obtain the scramble key “Ks”; thereby, de-scrambling it to be viewed/listened on them.

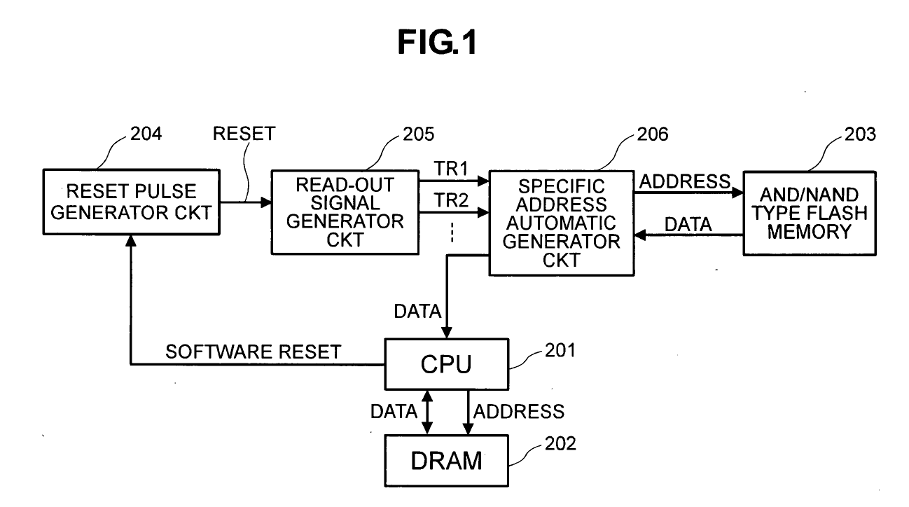

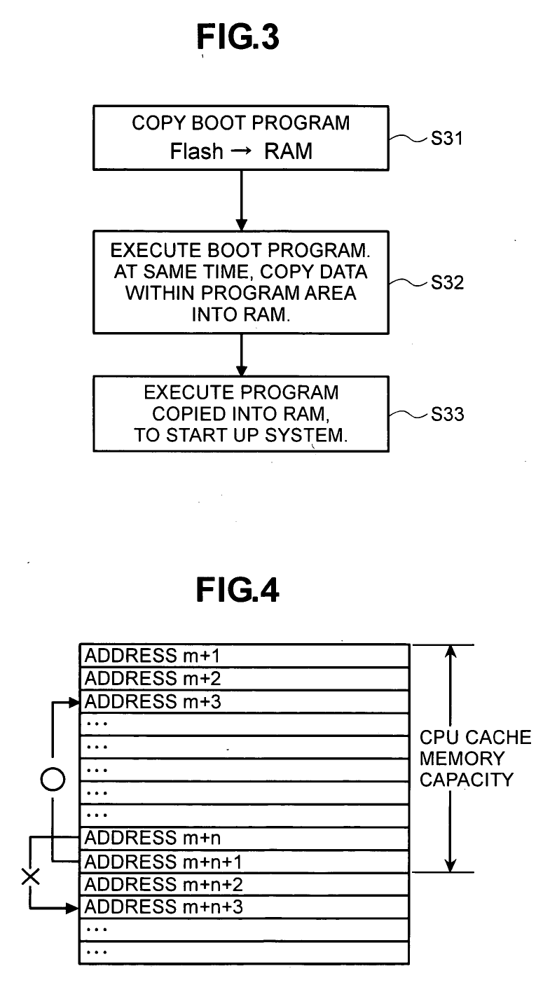

Next, in FIG. 1 attached herewith is shown the detailed internal structures of the controller 106, which is provided for executing the control on each of portions within the receiving system for digital broadcasting shown in FIG. 3 mentioned above. Thus, in this FIG. 1, the controller has a CPU 201, i.e., a central processing unit, and also, a DRAM 202, being a volatile memory device for storing data for use in calculation processing, and a flash memory 203 of “AND” type or “NAND” type, being anon-volatile memory device mentioned above, being electrically erasable and writable therein, within an outside thereof (or may be built within the CPU, as a unit).

However, it is possible to make a random access to the DRAM 202 mentioned above with an aid of an address from the CPU 201, thereby achieving the read-out and write-in of data between the CPU, and within the flash memory 203 of the “AND” type or “NAND” type is stored the control programs for starting up the present apparatus, i.e., the receiving system for use in digital broadcasting. Also, this flash memory 203 of the “AND” type or “NAND” type can carry out continuous read-out or write-in of data, by a unit of a specific block thereof (for example, by 32 bytes or 64 bytes) by inputting specific addresses therein, or it can carry out read-out of data of 256 bytes, continuously (namely, not at random) from the starting, for example, though depending upon the condition of read-out signals TR1, TR2 . . . , which will be mentioned later. And also, this flash memory 203 of the “AND” type or “NAND” type is suitable, in particular, for large-sizing in the memory capacity thereof, as was mentioned above, and in the present example, it is a non-volatile memory having a memory capacity of 16 Mbytes or more than that.

Further, this flash memory 203 of the “AND” type or “NAND” type comprises: a reset pulse generator circuit 204, being made up with a switch provided within the above-mentioned digital receiving system and so on, for example, and for generating a reset pulse for starting up the control program of the present receiving system for digital broadcasting; a read-out signal generator circuit 205 for generating the read-out signals TR1, TR2 . . . , from the specific addresses upon the reset pulse from the said reset pulse generator circuit; and an automatic address generator 206 of specific addresses (a specific address automatic generator), inputting the signals TR1, TR2 . . . from the read-out signal generator circuit and so on therein, for generating address signals AD to the specific addresses, for use of the continuous read-out of data thereof. Further, as is apparent from the figure, the following signals are inputted from the CPU mentioned above into the reset pulse generator circuit 204; such as, a signal for re-starting the control program and/or a software reset signal, but depending upon necessity thereof.

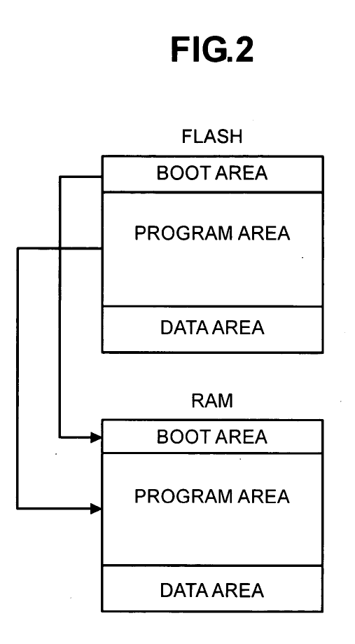

Following to the above, explanation will be given on the operation of the controller 106, the inner structure of which was shown in the above; in particular, about a start-up of the control program thereof, in particular, in the case when the switch of the receiving system for digital broadcasting is turned ON, or in the case when the software reset signal is generated from the CPU mentioned above, by referring to FIG. 2 attached herewith, as well as, FIG. 1 mentioned above.

First of all, when the switch of the receiving system for digital broadcasting is turned ON, or when the software reset signal is generated, the reset pulse (reset) is generated from the reset pulse generator circuit 204 mentioned above. While inputting this reset pulse therein, the read-out signal generator circuit 205 generates a signal being necessary for indicating the read-out of data from the specific addresses, such as, the TR1, for example. In accordance with this read-out signal TR1 of the specific addresses, which is provided from the read-out signal generator circuit 205, the specific address automatic generator circuit 206 produces the address signal (addresses) for the specific continuous addresses, in synchronism therewith, so as to output them to the flash memory 203 of the “AND” type or “NAND” type mentioned above. With this, from the flash memory 203 of the “AND” type or “NAND” type can be outputted the data, by a unit of data block of 32 bytes or 64 bytes, being continuous and stored within the specific continuous addresses.

Then, the CPU 201 mentioned above executes the start-up of the control program thereof, in accordance with a start-up method for the system shown in FIG. 2 mentioned above. Further, in the upper portion of FIG. 2 mentioned above is shown a data storage area within the flash memory 203 of the “AND” type or “NAND” type, on the other hand, in the lower potion thereof a data storage area within the RAM 202, which is accessible at random with an aid of the address signal from the CPU 201, respectively.

Firstly, the CPU 201 mentioned above reads the data therein, which is stored in a boot area, i.e., a boot program stored within the flash memory 203 of the “AND” type or “NAND” type, thereby executing the start-up. However, this boot program is stored in a predetermined area within the flash memory 203 of the “AND” type or “NAND” type, continuously, by the unit of data block mentioned above.

In more details thereof, as is shown in FIG. 3 attached herewith, the CPU 201 mentioned above starts up, through reading the boot program therein, which is read out from the boot area of the flash memory 203 mentioned above, and copies that boot program onto the RAM 202, thereby to extend it thereon (step S31). Thereafter, it executes the boot program upon the basis of the data, which is copied and extended on the RAM 202. At the same time, the CPU 201 also copies a program(s), being larger in the size than that of the boot program mentioned above, onto the other memory area having a large memory size, i.e., the RAM 202 (step S32). Further, the CPU 201 executes the program extended on the RAM 202 mentioned above, thereby starting up the present apparatus, i.e., the receiving system for digital broadcasting (step S33). In this manner, according to the present invention, it is possible to use the flash memory 203 of the “AND” type or “NAND” type; thus, the non-volatile memory of being cheap in the price and large in the memory capacity thereof. Further, it is also possible to copy and extend the data within the data area of the flash memory 203, if necessary, onto the RAM 202, in the similar manner to that mentioned above.

FIG. 4 attached herewith shows the arrangement of the start-up program, which is stored within the flash memory 203 of the “AND” type or “NAND” type mentioned above; thus, though being cheap in the price and large in the capacity, but a memory of a synchronous read-out type, therefore being characterized by the continuous read-out of data locating within the specific addresses thereof, as well as, the steps for executing the start-up program thereof.

Namely, in the flash memory 203 of the “AND” type or “NAND” type, since the data is read out from that locating at the specific address, continuously, through the read-out operation of the synchronous type, therefore it is necessary to store the start-up program into the continuous addresses within the memory. For example, in FIG. 4, it is shown that the start-up program is memorized or stored into the continuous addresses within the memory, such as, into the address m+1 to the address m+n+2, for example, wherein the CPU 201 executes the start-up program, in accordance with the processing steps, which are read out from those continuous addresses (i.e., from the address m+1 to the address m+n+2), sequentially.

In other words, as indicated by “x” in FIG. 4, for example, it means that the processing steps should not be disposed in so-called a discontinuous manner, such as, including a jump command therein, so that the processing step thereof makes a jump from the address m+n to the address m+n+3, for example. Herein, even in the case where the processing step makes a jump between the addresses, however, as is indicted by “O” in FIG. 4, if it turns back within a range of the cache memory capacity of the CPU 201 (for example, when it turns from the address m+n+1 back to the address m+3), since the process can be carried out by using the data stored within the cache memory of the CPU, then such the arrangement can be made on the processing steps, and therefore, such the arraignment of the processing steps should not be mentioned to be such the “discontinuous” one.

Next, explanation will be made hereinafter, about a variation of the electronic apparatus mentioned above, according to the embodiment of the present invention. Namely, among the CPU (see the reference numeral 201 in FIG. 1, for example) building up the controller 106 of the electronic apparatus shown in FIG. 5 mentioned above, i.e., the receiving system for digital broadcasting (so-called the Set Top Box (STB)), there may be a further type of CPU, which provides no such the read-out pulse therefrom when changing the read-out addresses. In such the case, under the circumstance where the CPU is connected to the flash memory of the “AND” type or “NAND” type mentioned above, the read-out pulse mentioned above will not be outputted therefrom; therefore, it is impossible to start up the system from the said flash memory, too.

Explaining this in more details thereof, as shown in FIG. 7 attached herewith, the CPU starts up the read-in of the flash memory when the reset upon the CPU is released, however in this instance, upon an assertion of one (1) time of an OE (i.e., Output Enable); thus, during the time period when the waveform OE in the figure is in “Low”, the address is changed four (4) times at the CPU side, for example. On the contrary to this, at the side of the flash memory, data of two (2) bytes are outputted, at the timing when the output enable (OE) is negated. With respect to the read-in operation of eight (8) bytes at the CPU side, only two (2) bytes of data are outputted at the flash memory side; therefore, it is impossible to carry out the read-in of the continuous data from the said flash memory having such the synchronous read-out function.

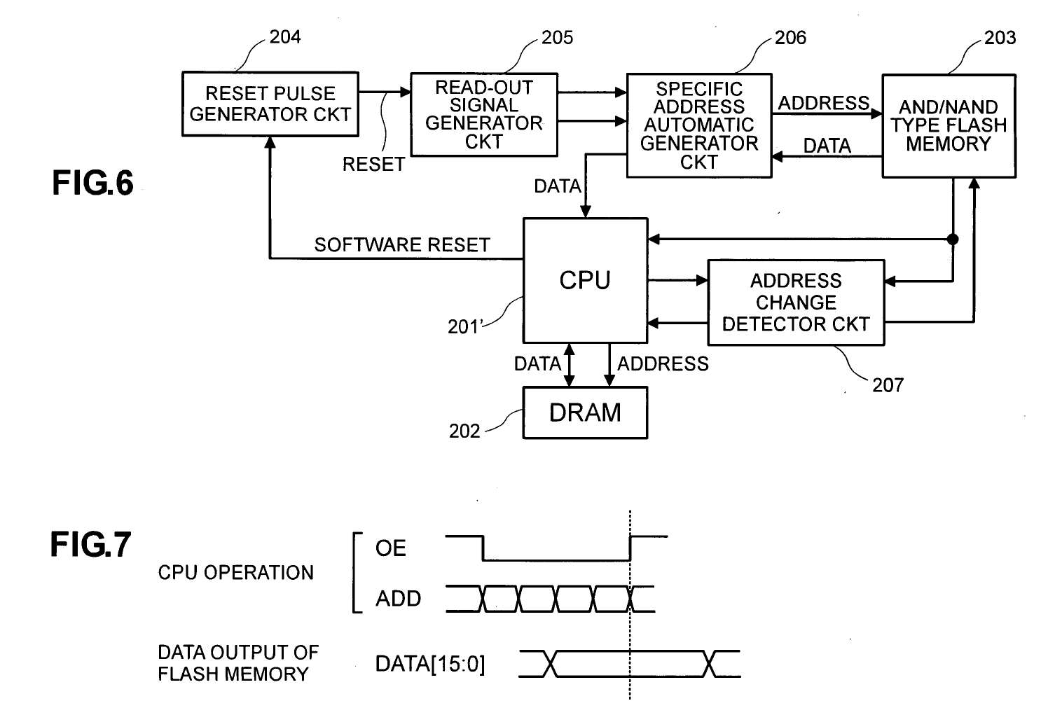

Then, according to the present invention, as is shown in FIG. 6 attached herewith, namely there is provided the structure of adding an address change detector circuit 207, further, in addition to the basic structure of the controller shown in FIG. 1 mentioned above. However, herein, a reference numeral 201′ depicts the CPU of that type of changing the addresses by a plural number of times upon one (1) time of assertion of the output enable (OE), as was mentioned in the above, but the other constituent elements attached with the other reference numerals are also same to those shown in FIG. 1 mentioned above.

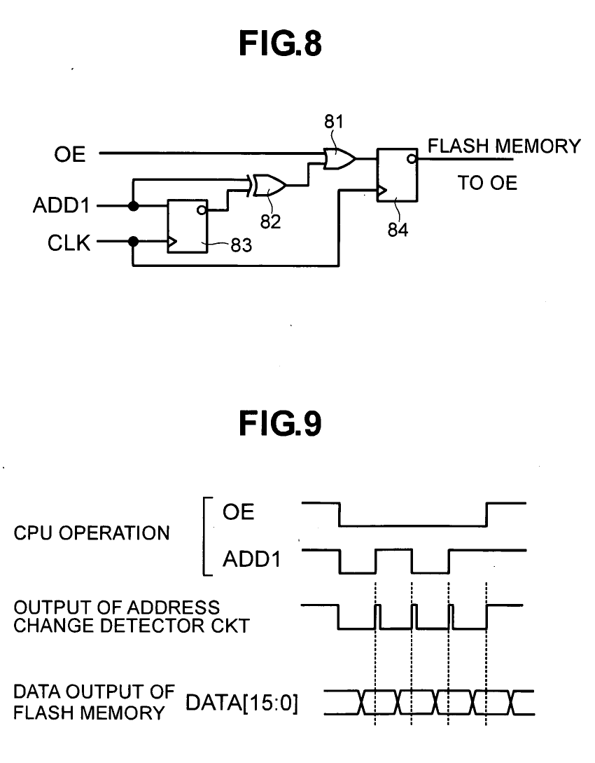

Further, an example of details of the circuit structures of this address change detector circuit 207 is shown in FIG. 8 attached herewith. Namely, in this figure, the address change detector circuit 207 is made of a circuit; comprising, an OR gate 81, an XOR gate 82, and two (2) pieces of flip-flop circuits 83 and 84 therein, and as is apparent from that structure; thus, it builds up a kind of a differentiation circuit, for detecting change of the address (ADD1) from the CPU side, so as to output a pulse signal therefrom.

Namely, with such the address change detector circuit 207 mentioned above, as is shown by the waveforms in FIG. 9 attached herewith, it can detect the change, even if the CPU side changes the address plural times at the least significant digit thereof through the assertion of one (1) time of the output enable (OE). And, it detects the change of the address, thereby to be guided into an OE terminal of the flash memory 203 of the “AND” type or “NAND” type mentioned above; therefore, it is possible to read out data from the flash memory in synchronism with that changes of addresses, even if the address ADD1 changes plural times during the time period of one (1) time of the OE in the CPU operation. Thus, it is also possible to execute the start-up of a system, with certainty, while also using the flash memory of the “NAND” type, i.e., the non-volatile memory of being cheap in the price and large in the memory capacity thereof, even within the system of building up the controller 106, for executing the control upon an apparatus, as a whole, by means of the CPU 201′ of the type of changing the address by plural times through the assertion of one (1) time of the output enable (OE).

However, in the embodiment mentioned in the above, though the description was made only about the example, where the present invention is applied into the receiving system for use in the digital broadcasting (i.e., the Set Top Box (STB)), however the present invention should not be restricted only to such the embodiment as was mentioned above, but it may be also applied into other electronic apparatuses, widely, being relatively small in the sizes thereof; such as, a portable telephone apparatus or the like, for example, in particular, in which it is demanded to apply a semiconductor memory as a memory for storing the control programs therein.

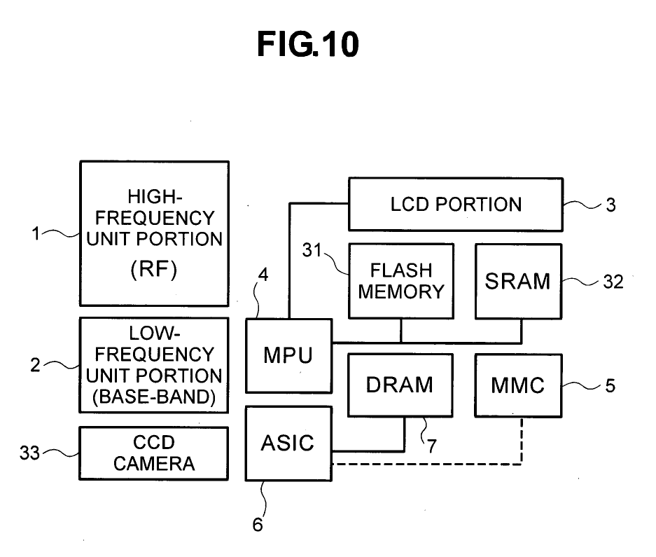

FIG. 10 attached herewith is a block diagram for showing the inner structure, when applying the present invention into the portable telephone apparatus, in particular, the portable telephone apparatus of so-called a high performance type, which comprises therein a PDA function and/or a digital camera function, in addition to those functions of the portable telephone apparatus of the standard type. In general, as is shown in the figure, the portable telephone apparatus comprises a high-frequency unit portion 1, a low-frequency unit portion 2, a liquid crystal display portion 3, a MPU 4 for use of system control, a flash memory 31 for storing programs of the system control and/or a table of telephone numbers therein, and a SRAM 32 to be used for execution of the programs and/or as a buffer for data. Further, for the purpose of adding highly advanced functions, such as, the PDA function and the digital camera function, etc., mentioned above, onto the portable telephone apparatus, there are further installed an interface between external media and a DRAM for handling data which comes to be further large in an amount thereof. Furthermore, there is also provided a CCD camera 33 therein.

And, in such the structure of the portable telephone apparatus of such the high performances as was mentioned above, in particular, in relation to the flash memory 31 mentioned above, there is also applied the flash memory of the “AND” type or “NAND” type, as was shown in FIG. 1, and also there are further provided the reset pulse generator circuit 204, the signal generator circuit 205, the automatic specific address generator circuit 206, and also, but depending upon the necessity thereof, the address change detector circuit 207. With such the structure as was mentioned above, also in the similar manner as was mentioned, it is possible to use the flash memory of the “NAND” type, i.e., the non-volatile memory being cheap in the price and large in the memory capacity thereof, to be the memory for storing the control programs therein. Moreover, but depending upon the necessity thereof, with the data within the data area of the flash memory 31 mentioned above, they can be extended on the RAM 32 through copying thereof.

Also, though the flash memory of the “AND” type or “NAND” type is explained to be such the semiconductor memory, which can be mounted thereon to be the memory for use of storing the control programs therein, representatively, in the explanation that was made in the embodiments mentioned above, however the present invention should not be restricted only to those, but other than those, it is needless to say, it is also possible to apply such the non-volatile memory, as the memory for storing the control programs therein, if being erasable and writable of data therein, electrically, and if it has a function of reading out the data locating at the specific addresses, with applying the present invention therein.

As was fully explained in the above, with the electronic apparatus, according to the present invention, and further the start-up method of the system in such the apparatus, since it is possible to executes the start up of the system, with using the flash memory of the “NAND” type mentioned above, i.e., the semiconductor non-volatile memory being cheap in the price and large in the memory capacity thereof, as the memory for storing the control programs therein; thereby achieving an extremely superior effect, practically, of enabling to provide an electronic apparatus being cheap, as well as, superior in the functions thereof.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications, which fall within the ambit of the appended claims.

1. An electronic apparatus, having a controller portion for executing control on each part of said apparatus, wherein said controller portion comprises:
a central processing unit;
a volatile memory portion, being connected with said central processing unit and accessible at random thereto;
a non-volatile memory portion, being connected with said central processing unit and electrically erasable and writable data thereof; and
a reset signal generator portion for generating a reset signal for executing start-up of a system, wherein
said non-volatile memory portion is made up with a flash memory, having a function of reading out data locating at specific addresses, continuously, and also storing a boot program for executing start-up of the system in a part thereof, and further, said controller portion comprises means for generating said specific addresses responding to the reset signal from said reset signal generator portion, whereby said central processing unit starts up upon basis of the boot program, which is read out from said non-volatile memory portion continuously.

2. The electronic apparatus, as described in the claim 1, wherein said central processing unit extends the data, which are read out continuously from said non-volatile memory, on the volatile memory portion, being connected with said central processing unit and accessible at random thereto, as well as, starting up upon basis of the boot program, which is read out from said non-volatile memory portion continuously.

3. The electronic apparatus, as described in the claim 1, wherein said controller portion further comprises a means, for producing a signal so as to read out the data locating at the specific addresses continuously, responding to the reset signal from said reset signal generator portion, thereby outputting them to said non-volatile memory portion.

4. The electronic apparatus, as described in the claim 1, wherein in said non-volatile memory portion is stored said boot program, sequentially, at the specific continuous addresses thereof.

5. The electronic apparatus, as described in the claim 1, wherein in said controller portion further comprises an address change detector circuit for inputting addresses from said central processing unit, so as to detect change thereof.

6. The electronic apparatus, as described in the claim 1, wherein said apparatus is applied into a receiving system for digital broadcasting.

7. The electronic apparatus, as described in the claim 1, wherein said apparatus is applied into a portable telephone apparatus.

8. A method for starting up a system within an electronic apparatus having a controller portion for executing control on each of portions of the apparatus, wherein said controller portion comprises: a central processing unit and a non-volatile flash memory, being electrically erasable and writable data thereof and having a function of reading out data locating at specific addresses thereof, continuously, comprising the following steps of:
storing a boot program for starting up a system into a portion of said non-volatile flash memory portion; and
reading out said boot program, continuously, from said non-volatile flash memory portion, when a reset signal for starting up said system is generated, whereby executing the start-up.

9. The method for starting up a system, as described in the claim 8, wherein said boot program is stored, sequentially, at specific continuous addresses within said non-volatile flash memory portion.

10. The method for starting up a system, as described in the claim 8, wherein said controller portion further comprises a volatile memory portion being connected with said central processing unit and accessible at random to data thereof, and further said central processing unit starts up upon basis of the boot program, which is read out from said non-volatile memory portion, continuously, and also extends the data continuously read out from said non-volatile memory portion onto the volatile memory portion, being connected with said central processing unit and accessible at random to data thereof.
